(19) United States
(12) Patent Application Publication
(10) Pub. No.: US 2008/0101916 A1
(43) Pub. Date: May 1, 2008

(54) Method and system for deriving wind speed in a stall controlled wind turbine

(76) Inventor: David Calley, Flagstaff, AZ (US)

Correspondence Address: ARENT FOX LLP, 1050 CONNECTICUT AVENUE, N.W., SUITE 400, WASHINGTON, DC, 20036, US

(21) Appl. No.: 11/976,201

(22) Filed: Oct. 22, 2007

Related U.S. Application Data
(60) Provisional application No. 60/853,036, filed on Oct. 20, 2006.

(51) Int. Cl. F03D 7/00

(52) U.S. Cl. 415/1; 415/17

(57) ABSTRACT

Methods and systems for improving stall controlled wind turbine effectiveness by accurately determining wind speed without using an anemometer or other independent wind speed measuring device. Wind speed may be determined, among other methods, by tracking a mapped TSR model with respect to an operating stall controlled wind turbine in a given TSR range; decreasing a Ramp Start RPM value upon reaching a maximum desired power level and by following a mapped RPM into ramp (the control going into RS) for the desired wind speed range; upon reaching a desired RPM level, raising the RPM with power; and/or using periodic unloading of the rotor. The wind speed information may be utilized to control wind turbine parameters.

### RELATED APPLICATIONS

This application claims the benefit of U.S. Provisional Patent Application Ser. No. 60/853,036 titled “Method and System for Deriving Wind Speed in a Stall Controlled Wind Turbine” filed Oct. 20, 2006. This application is also related to U.S. patent application Ser. No. 11/487,392 titled “Wind Turbine and Method of Manufacture” filed Jul. 17, 2006, and to U.S. patent application Ser. No. 11/487,343 titled “Stall Controller and Triggering Condition Control Features for a Wind Turbine” filed Jul. 17, 2006. The entirety of each of the above applications is incorporated by reference herein.

### BACKGROUND OF THE INVENTION

1. Field of the Invention

Embodiments of the present invention relate to the field of wind turbines, and in particular to methods and systems for improving the productivity and cost effectiveness of stall controlled wind turbines by deriving the wind speed in a cost-efficient manner and using such information to limit loads in higher winds where less annual energy is produced.

2. Background of the Technology

A problem with existing wind turbines is that, in order to optimize the cost of the wind turbine and for reasons related to productivity, loads generally need to be minimized. Most large wind turbines address such load problems through use of an anemometer, placed, for example, at a location near or on the wind turbine. The anemometer allows the speed of the wind to be determined so that wind turbine operation can be adjusted responsive to wind speed in order to limit loads in less productive wind conditions.

However, a difficulty with existing small, stall regulated wind turbines, for example, is that, as they respond to higher wind conditions and dip into the stall region, they lose the ability to determine wind speed. For example, for a fixed RPM stall controlled wind turbine, as wind speed increases, the power produced by the wind turbine increases up to a maximum level (interchangeably referred to herein as “peak power”), without a change in the Revolutions Per Minute (RPM) of the turbine. However, as wind speed continues to increase above the speed at which peak power is produced, the output of the wind turbine actually decreases, due to aerodynamic characteristics of the turbine. Among other things, this result means that after peak power, when the power is decreasing, the decrease may be due to the wind speed either rising or falling. There exists no known method or system in the prior art to determine wind speed under these conditions, without a separate anemometer.

In particular, with a stall regulated wind turbine design, there is an angle at which an airfoil is most efficient (i.e., the airfoil has maximum lift over drag). If the pitch of the airfoil increases beyond the most efficient angle, lift may continue to rise, but drag rises more quickly, such that, at some point, stall is reached. At stall, lift does not continue to rise, while drag continues to rise. As a result, the airfoil becomes increasingly less efficient as the angle continues to change. From the point of view of a wind turbine designer, it may be useful to describe this pitch in terms of “tip to wind speed ratio” or “TSR.”

A further problem, particularly with smaller wind turbines, is that the cost of an anemometer and features designed to utilize received anemometer information may be prohibitive for some intended applications (e.g., low cost residential use), and the complexity associated with use of an anemometer may be detrimental to cost, operation, or reliability, for example. In addition, if an anemometer is mounted to a small wind turbine, the information produced from the anemometer under some conditions may be inaccurate, for example, because the turbine's operation may interfere with the wind speed reading. The anemometer may also fail, or produce inaccurate results under certain conditions.

If the anemometer fails, the wind turbine may be potentially damaged by high wind conditions. Further, for some small wind turbine applications, if the anemometer is located separately from the wind turbine, a separate tower or other mounting device may be required, which can raise financial, aesthetic, zoning, or other concerns.

With regard to the control problem for such wind turbine applications, while existing methods may be effective for limiting power in fixed RPM wind turbines, these existing approaches may not sufficiently limit certain other load concerns (e.g., base bending moments on the tower; main loads on the turbine propeller shaft; flapwise bending moments on the blade). For example, in some operating conditions, such loads are independent of power and RPM. In these conditions, for example, load may continue to rise with rising wind speed. However, loads in these conditions can be controlled if wind speed is known. Thus, costs associated with the wind turbine can be reduced (e.g., costs associated with either additional strength, rigidity or other features needed to address such increased loads, or with the need to use a larger rotor for greater swept area can be reduced).

A typical situation in which increased load conditions exists is as follows. Wind turbine operation is at peak power, and power and RPM are known. If power decreases (which it must from peak power for any changing condition), absent measured information on wind speed, it will be unknown whether the power decrease is due to increased wind speed or decreased wind speed. As a result, in the existing art for a stall controlled wind turbines, for example, the wind speed cannot be determined only from RPM and power information.

There is an unmet need in the art, therefore, for cost-efficient and accurate methods and systems to derive wind speed in stall controlled wind turbines, in order to be able to increase the productivity or reduce cost of such wind turbines (e.g., by decreasing loads in high winds or by increasing productivity).

### SUMMARY OF THE INVENTION

Embodiments of the present invention overcome the above identified problems, as well as others, by providing a method and system for accurately determining wind speed for stall controlled wind turbines, without using an anemometer or other independent wind speed measuring device. The wind speed information can be used to improve small wind turbine cost effectiveness. Wind speed, according to embodiments of the present invention, may be determined by following or tracking a mapped TSR model with respect to an operating stall controlled wind turbine in a given TSR range. Further, wind speed may be determined by decreasing a Ramp Start RPM value upon reaching a maximum desired power level, and by following a mapped RPM into ramp (the control going into RS) for the desired wind speed range. Moreover, wind speed may also be determined by, upon reaching a desired RPM level, raising the RPM with power. In addition, wind speed may also be determined, in accordance with embodiments of the present invention, by using periodic unloading of the rotor.

One advantage of obtaining wind speed information using the method and system of embodiments of the present invention is that the wind speed information may be provided to a user of the wind turbine (e.g., via a wind speed readout). More importantly, embodiments of the present invention allow certain loads on the wind turbine to be controlled via use of the wind speed information to control relevant wind turbine parameters.

Additional advantages and novel features of the invention will be set forth in part in the description that follows, and in part will become more apparent to those skilled in the art upon examination of the following or upon learning by practice of the invention.

### BRIEF DESCRIPTION OF THE FIGURES

In the drawings:

FIG. 1 shows a cross-sectional view of an exemplary wind turbine usable with embodiments of the present invention;

FIG. 2 is a representative block diagram of various wind turbine components, including features relating to the method and system for embodiments of the present invention;

FIGS. 3A-3B present exemplary flow diagrams of methods of operation in accordance with embodiments of the present invention;

FIG. 4 contains a representative system diagram of various components usable with embodiments of the present invention, as well as the indicated representative functionality therefor;

FIGS. 5-8 show exemplary graphical mapping of wind speed versus power for specific TSRs in an exemplary wind turbine, for use in accordance with exemplary embodiments of the present invention;

FIG. 9 shows the changes in the “Ramp Start” RPM, power out, and “RPM into Ramp” parameters with the increase in wind speed, in accordance with an exemplary embodiment of the present invention;

FIGS. 10A-10C show plots of wind speed vs. RPM, wind speed vs. Electrical Power, and wind speed vs. TSR, in accordance with an exemplary embodiment of the present invention; and

FIGS. 11A-11C show plots of wind speed vs. Rotor RPM and Time vs. Rotor Power, in accordance with an exemplary embodiment of the present invention

### DETAILED DESCRIPTION

Description of exemplary embodiments of the present invention will now be made with reference to the appended drawings.

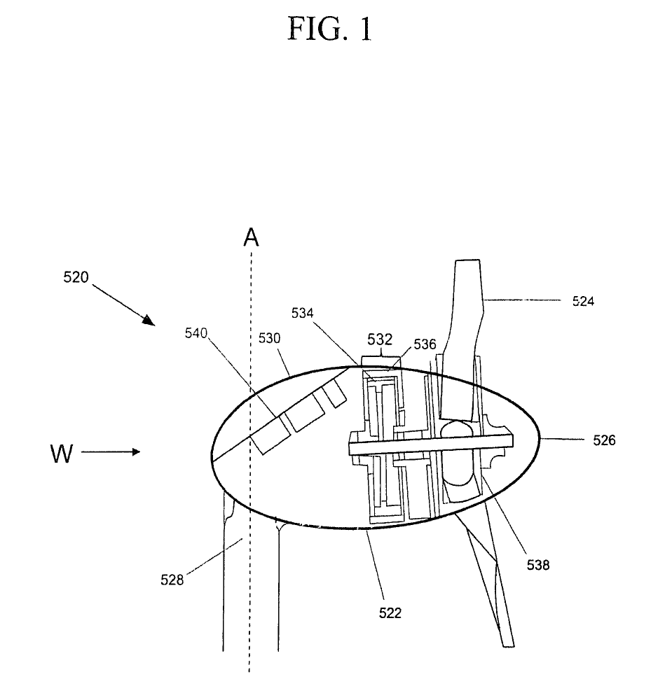

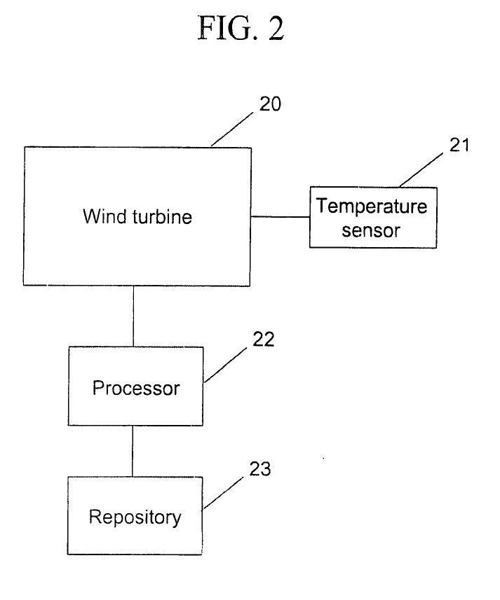

Referring now to FIG. 2, therein shown is a representative block diagram of various wind turbine components (a cross-sectional view of an exemplary wind turbine usable with embodiments of the present invention being shown in FIG. 1), including features relating to the method and system of the present invention. As shown in FIG. 2, the wind turbine 20 includes or is coupled to a processor 22 having or capable of accessing a repository of data 23, such as a database. The wind turbine 20 optionally includes a temperature sensor 21 or is coupled to a temperature sensor 21.

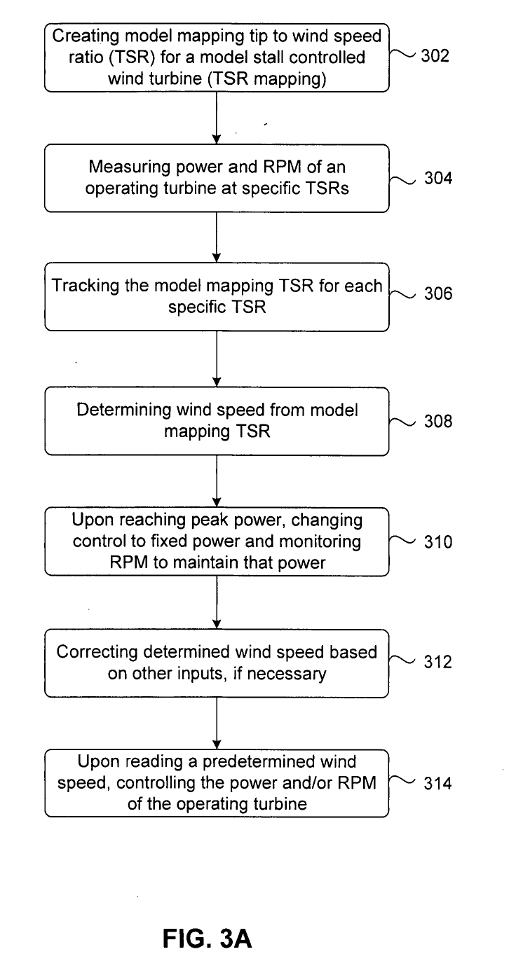

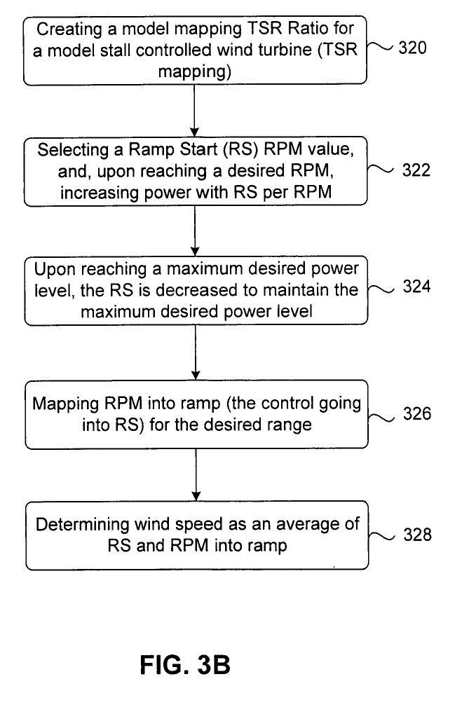

FIG. 3A presents an exemplary flow diagram of one method of operation of an embodiment of the present invention, in which mapping of tip to wind speed ratio (TSR mapping) may be used to determine wind speed. In one embodiment, the method and system of the present invention includes use of an experimentally or otherwise determined mapped range of TSR in which a model wind turbine operates as a function of its “Coefficient of Power” or “CP.” As shown in FIG. 3A, a model mapping TSR for a model stall controlled wind turbine is created or obtained 302. For example, to create such mapping, an anemometer to measure wind speed may be used in conjunction with a device for measuring wind tip speed (e.g., based on measured blade RPM) to chart tip speed to wind speed ratios of interest for each identified TSR. Such ratios of interest may include, for example, ratios ranging from that for the wind speed occurring at peak efficiency to the wind speed at which power needs to be limited. Generally, these will be TSRs lower than the best efficiency TSRs. As an example, the best efficiency (CP) may occur at a TSR of 7 to 1. In order to regulate stall, the TSR will have to be reduced to reduce loads. This regulation may include situations for all TSRs down to the TSR at which the turbine will shut down, or the highest wind speeds that it will operate in (e.g., TSR≅1) occur. The mapped model may be obtained or created 302, for example, experimentally or otherwise (e.g., via modeling).

Referring again to FIG. 3A, the power and RPM of an operating stall controlled wind turbine, operating at specific TSRs, are measured 304. The wind speed of the operating turbine is determined 308 by tracking each identified TSR 306 in reference to the mapped model. Upon reaching peak power, control is changed to fixed power, and the RPM required to maintain that power is monitored 310. Power output information and RPM of the turbine are measured, and the wind speed information is determined 308, by following the mapped model (which may be, for example, codified as a series of instructions to be performed by a microprocessor) 306. By following the mapped results for a given TSR, if the power increases, the wind speed must have increased, and with the mapped model, the wind speed can then be substantially accurately known and followed and then shifted to a new desired TSR. However, if the TSR is not tracked (interchangeably referred to herein as “followed”), the wind speed cannot be determined from the measured power and RPM, because there may be different solutions for the same power and RPM point. If, however, the TSR is tracked or followed, then the known state can be maintained, and thus wind speed can be derived.

The determined wind speed 308 may be corrected 312 based on additional inputs, such as temperature and operating altitude, if necessary. Upon reaching a determined or selected wind speed, the power output of the operating turbine and/or the RPM of the operating turbine may be controlled 314.

Referring now to FIG. 3B, therein shown is an exemplary flow diagram of a second method of operation of an embodiment of the present invention, in which TSR mapping 320 may also be used to determine wind speed, as described above in reference to FIG. 3A, with mapping of two additional parameters.

The first additional parameter is a moving “Ramp Start” (RS) and the second is “RPM into Ramp” (RPM-R). The changes in each of these parameters with the increase in wind speed are shown in FIG. 9. The RS parameter 902 is a variable moving “Ramp Start” control RPM. “Ramp Start” is the RPM at which the control begins to rapidly increase power 904 to control the RPM. For example, if the RS is set to a value of 120 watts per RPM, when the RPM reaches a value of about 320, the control starts increasing power 904 by 120 watts per RPM. This RS value 902 is reduced if the power rises above a preset maximum desired power level. In the example shown in FIG. 9, the preset maximum power level is set to about 2400 watts. As shown in FIG. 9, for wind speeds between about 10 m/s and 17 m/s, the RS 902 is pushed down by the control to maintain the preset desired 2400 watt setting.

The second additional parameter “RPM into Ramp” (RPM-R) 906, represents the RPM of the control going into RS 902. In this example, the RS value reaches about 15 RPM at about 13.5 m/s. Therefore, the power required to maintain control is adding 15×120 or 1800 watts. This variable is then also mapped for the desired wind speed range.

Referring again to FIG. 3B, a RS RPM is selected, and, upon reaching a desired RPM, the power is increased by the selected RS per RPM. Upon reaching a maximum desired power level, the RS parameter is reduced in order to maintain the maximum desired power level 324. The control going into RS, RPM into Ramp, is mapped for the desired range 326. In this embodiment, wind speed can be selected or determined by an average value for the variables “RS” and “RPM into Ramp.”

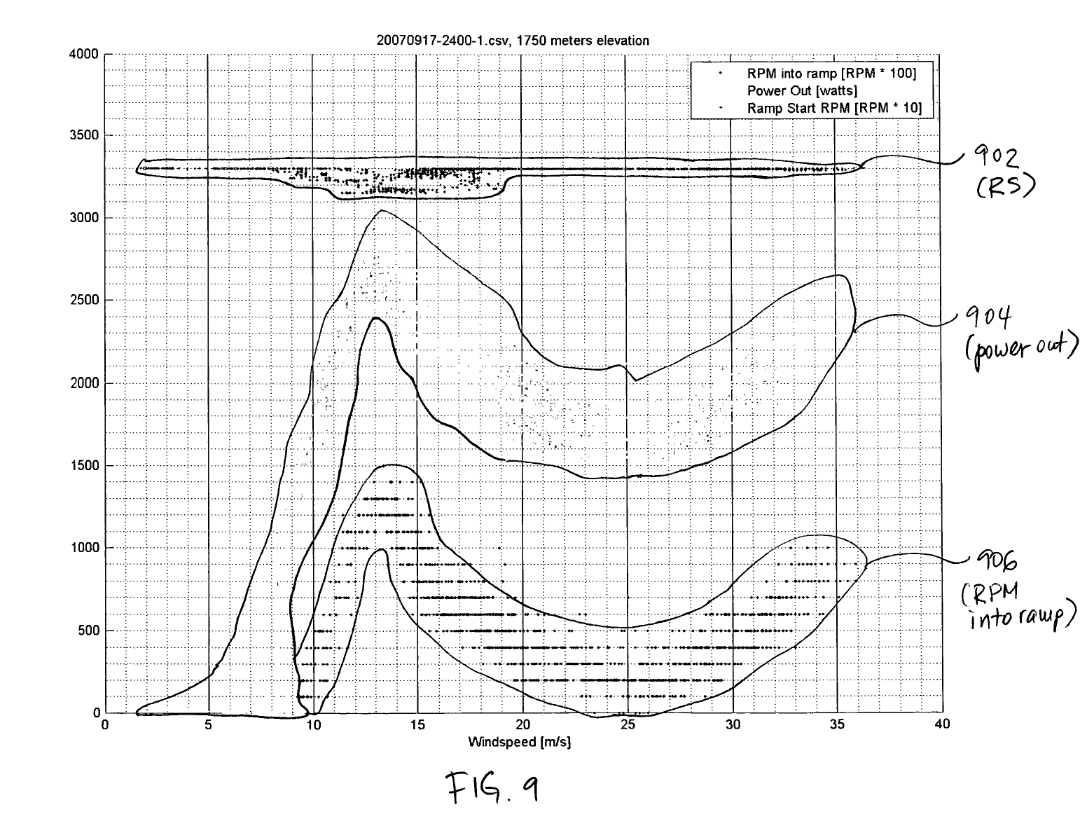

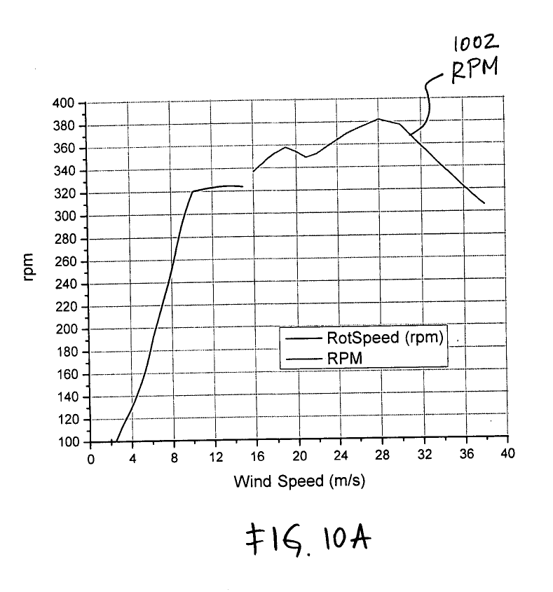

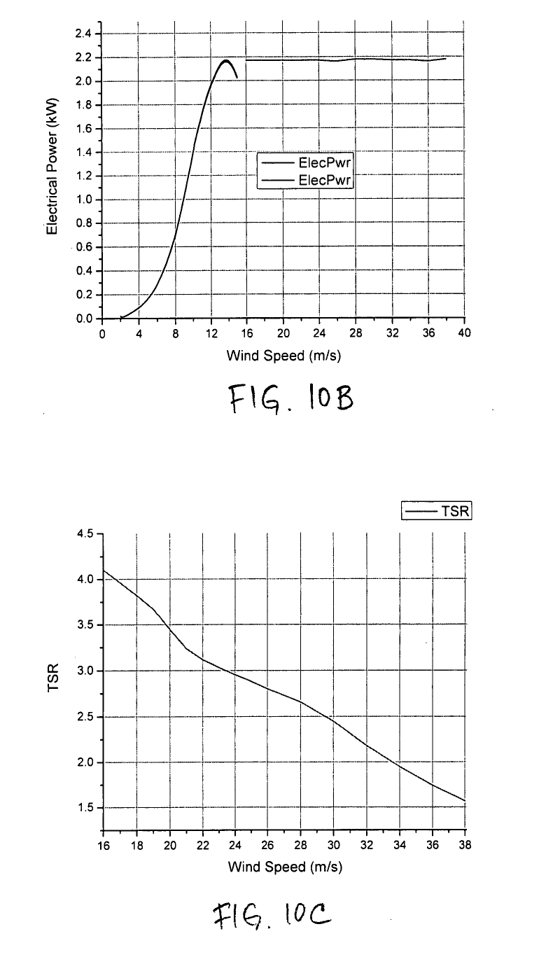

Referring now to FIG. 3C, therein shown is an exemplary flow diagram of a second method of operation of an embodiment of the present invention, in which wind speed is determined as described above in reference to FIG. 3B, the difference being that once a preset RPM is reached, the RPM rises with power as illustrated in FIGS. 10A-10C. FIG. 10A shows wind speed vs. RPM with line 1002 representing manually setting the RPM of the rotor to produce a desired electrical power of 2.17 kW. The wind speed vs. RPM values to produce a desired output of 2.17 kW for this example is represented below in Table 1.

TABLE 1
RPM needed to keep Electrical Power = 2.17 kW.

| wind speed (m/s) | rpm | Elect. Power (kW) | TSR |
|---|---|---|---|
| 16 | 337 | 2.17 | 4.10 |
| 18 | 353 | 2.17 | 3.82 |
| 19 | 358 | 2.17 | 3.67 |
| 20 | 354 | 2.17 | 3.45 |
| 21 | 349 | 2.17 | 3.24 |
| 22 | 352 | 2.16 | 3.12 |
| 23 | 358 | 2.17 | 3.03 |
| 24 | 364 | 2.17 | 2.95 |
| 25 | 370 | 2.18 | 2.88 |
| 26 | 374 | 2.16 | 2.80 |
| 27 | 378 | 2.16 | 2.73 |
| 28 | 382 | 2.18 | 2.66 |
| 30 | 377 | 2.18 | 2.45 |
| 32 | 358 | 2.17 | 2.18 |
| 34 | 340 | 2.17 | 1.95 |
| 36 | 322 | 2.16 | 1.74 |
| 38 | 306 | 2.18 | 1.57 |

Referring again to FIG. 10A starting with a RS value of about 320 RPM, the RPM of the RS is allowed to rise up to 380 by RPM.

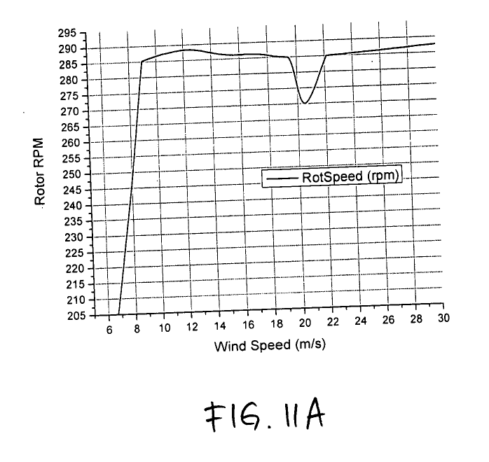

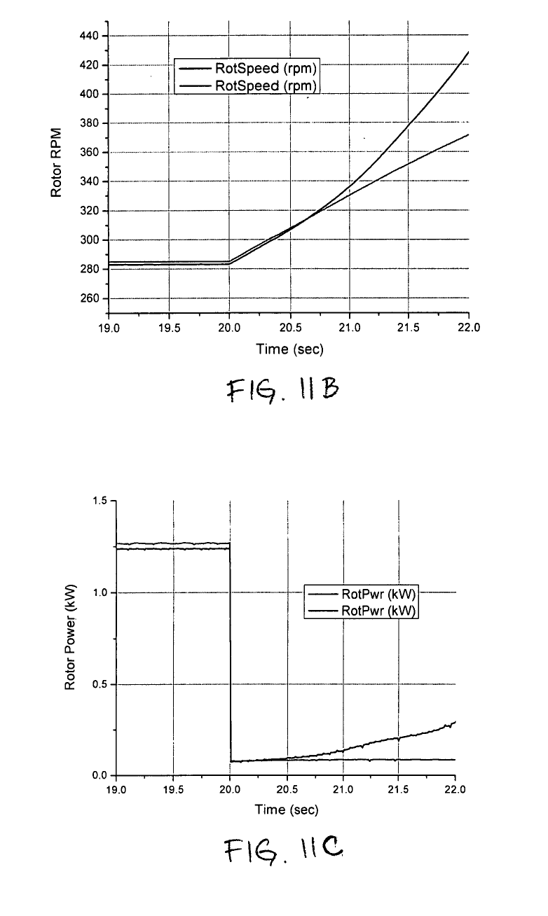

The fourth exemplary system and method in accordance with an embodiment of the present invention utilizes a periodic unloading of the rotor, as shown in FIG. 3D. FIGS. 11A-11C illustrate how the rotor responds to unloading in high vs. low winds. This method is used to test the wind speed in areas of operation when there is not certainty, for example.

It will be obvious to those of ordinary skill in the art that each of the above described methods may be used, alone or in combination with other described methods, to determine the wind speed of a stall controlled wind turbine.

Upon reaching a desired level of power, because the wind speed (e.g., increase or decrease) is known/determined via one of the above described methods, a determination may be made with respect to the cost-efficiency of operating the turbine at higher wind speeds. For example, a manufacturer of a turbine may determine that although it is desirable for a turbine to operate above a given wind speed (e.g., 25 m/s), as that wind speed occurs infrequently, increasing the sturdiness of the turbine for withstanding the high loads at that speed is not cost-efficient. Thus, the power output for wind speeds above 25 m/s may be decreased, or the turbine may be stopped from operation, until the wind speed has decreased. If the turbine is stopped, it may be stopped for a set time (e.g., 2 hours), or it may be desirable to continue to operate at reduced load, in order to continue to monitor wind speed. If the turbine is stopped for a time, it may be desirable to resume operation in a safe, low load mode that allows wind speed to be monitored, until a determination may be made as to whether the wind speed is low enough for resuming regular operation. Alternatively, it may be desirable to simply maintain operation in high winds but at reduced loads.

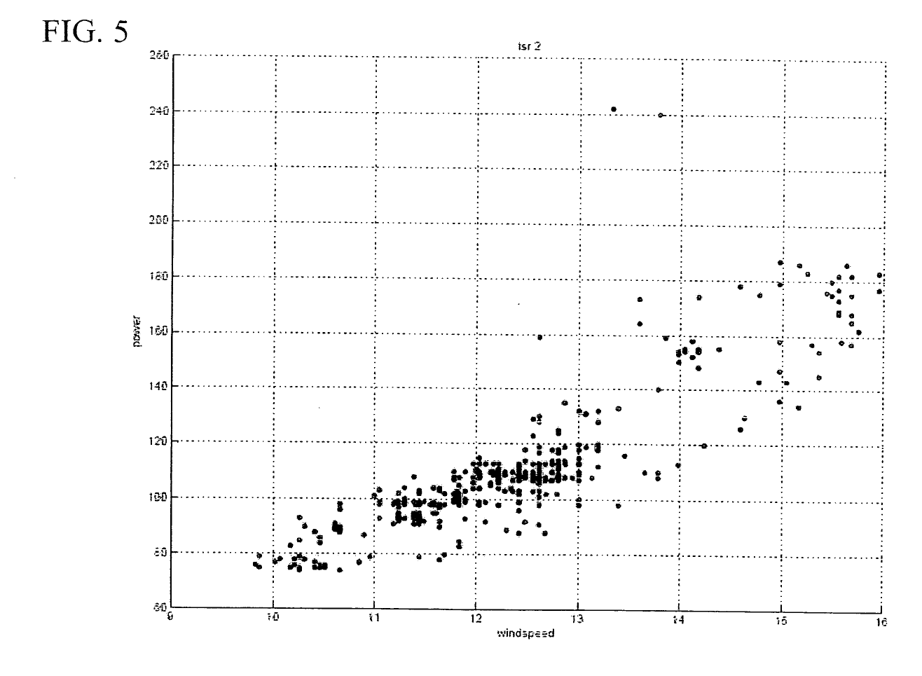

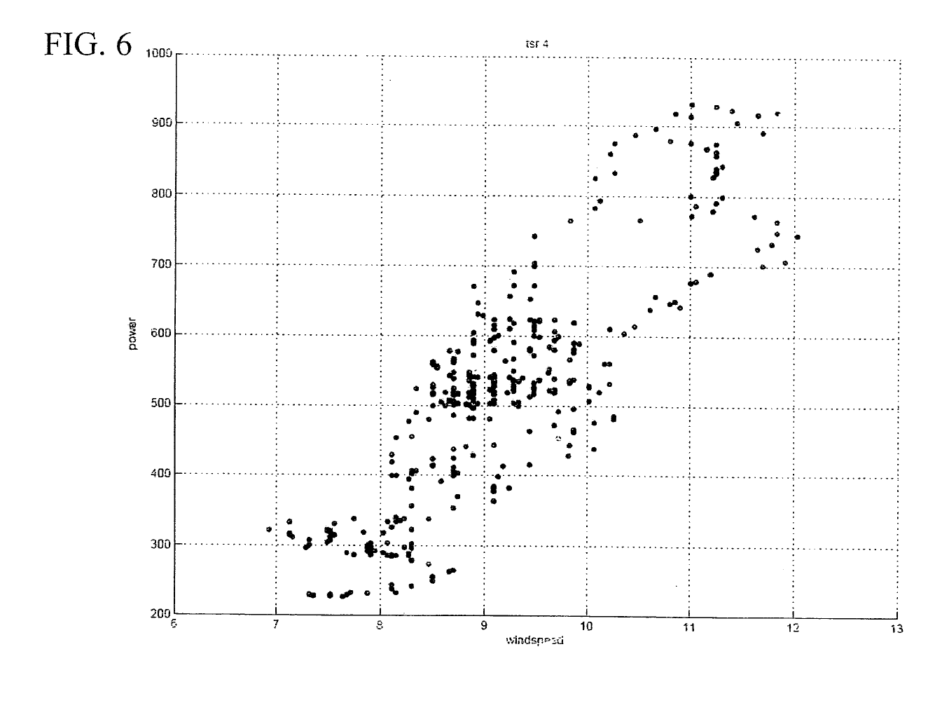

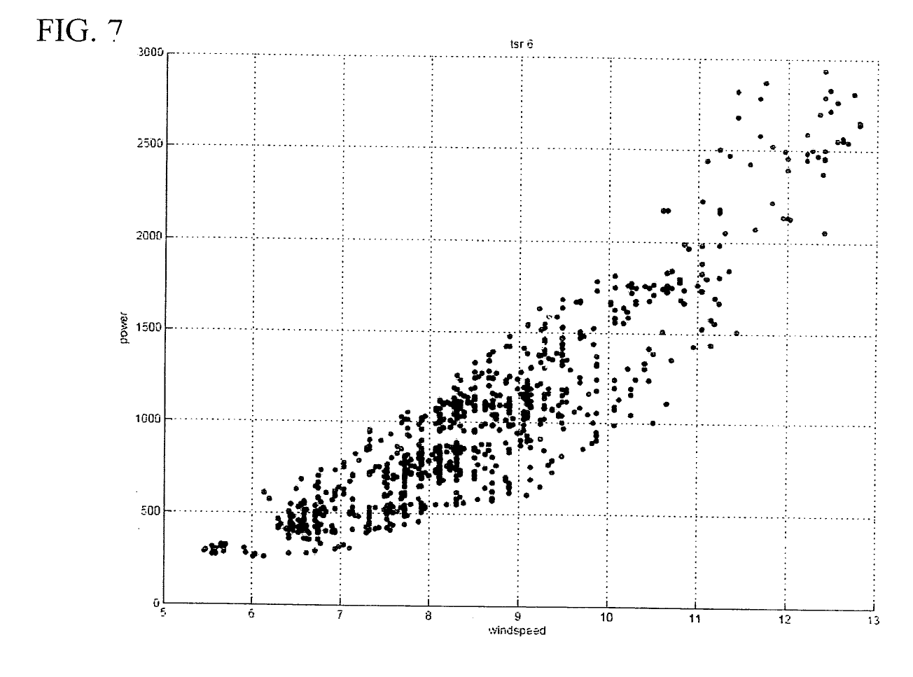

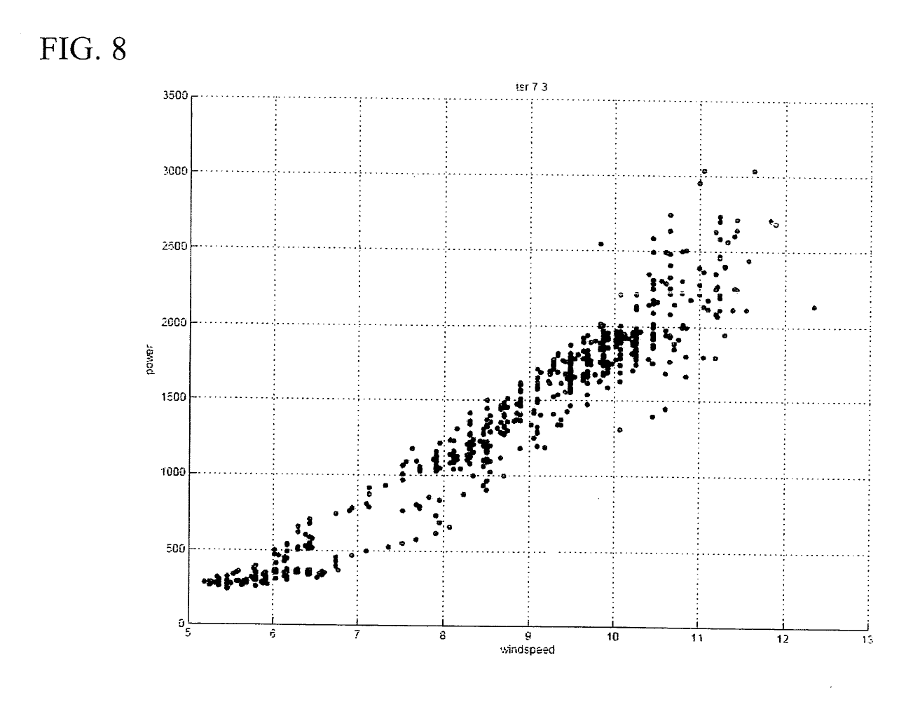

FIGS. 5-8 show exemplary graphical mapping of wind speed versus power for specific TSRs in an exemplary wind turbine, for use in accordance with embodiments of the present invention.

A method and system for operation in very high winds with low loads at a very low TSR (such as TSR=1) may be used in some embodiments of the present invention. A very low TSR will exhibit similar loads to a locked rotor. However, this low speed operation can be mapped, such as with the method described above in reference to FIG. 3A, while wind speed can still be reliably measured so that a restart wind speed can be selected and the turbine controlled by this variable.

Air density and the altitude of installation of the wind turbine can also affect the determination of wind speed. Thus, to further refine the mapping and to enable more accurate determination of when to increase or decrease stall, for example, air temperature sensing (e.g., via a temperature sensor incorporated in the wind turbine or otherwise coupled to a processor for performing the method of embodiments of the present invention) may be included as an input, along with inputting altitude to determine air density.

Yet another input that is helpful with further refining the precision of the method and system of various embodiments of the present invention is information on the inertia of the blade of the wind turbine. Blade inertia can, for example, typically be modeled in an experimental setting as a function of RPM and/or other wind turbine operation characteristics to produce a formula of inertia for such wind turbine operating characteristics. Alternatively or in addition to experimental methods, modeling by software (e.g., FAST) may be used. Inertia information can be further used to refine the determination of wind speed by allowing kinetic energy due to change in inertia of the blade to be separated from energy due to changes in wind speed, for example. The determination of impact of inertia at any point in wind turbine operation can be made, for example, by allowing a small change in RPM to occur, and measuring various operational factors in conjunction with use of the inertia mapping information.

While more precise results using such additional inputs as air density, altitude, and blade inertia are helpful, in some embodiments, such as those in which one use of the present invention is to control wind turbine operation in extreme conditions (e.g., high winds), the additional precision provided by use of these additional inputs may be unnecessary for some conditions.

Once the wind speed is determined to a desired level of accuracy, using, as necessary, any of the additional inputs described above in addition to the methods described above for determining wind speed according to exemplary embodiments of the present invention, the power of the wind turbine can be controlled to maximize efficiency.

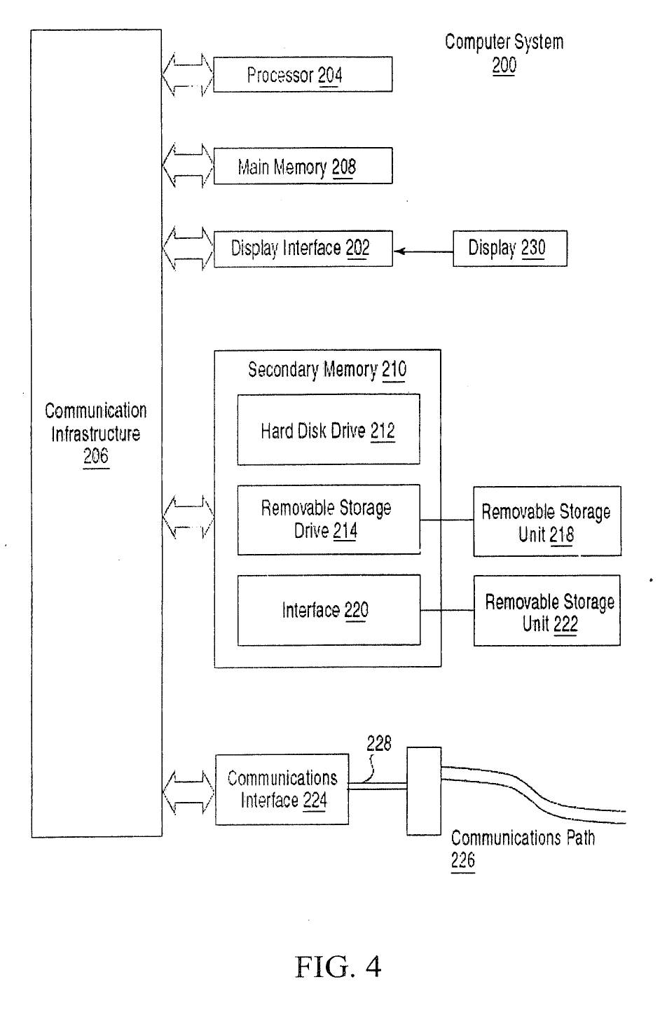

The present invention may be implemented using hardware, software or a combination thereof and may be implemented in one or more computer systems or other processing systems. In one embodiment, the invention is directed toward one or more computer systems capable of carrying out the functionality described herein. An example of such a computer system 200 is shown in FIG. 4.

Computer system 200 includes one or more processors, such as processor 204. The processor 204 is connected to a communication infrastructure 206 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well-known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative embodiments, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products. It will be recognized by those of ordinary skill in the art that different variations of the computer system 200 may be used to successfully implement embodiments of the present invention. For example, wired or wireless communication interfaces may be used with equal success.

Computer programs (also referred to as computer control logic) are stored in main memory 208 and/or secondary memory 210. “Set points,” such as elevation, and other technician-input or usable adjustable parameters may also be set and stored in memory. Computer programs (such as updated and improved performance versions) may also be received via wireless communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an embodiment where the invention is implemented using software, the software may be stored in a computer program product and loaded into computer system 200 using removable storage drive 214, hard drive 212, or communications interface 224. The control logic (software), when executed by the processor 204, causes the processor 204 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

While the present invention has been described in connection with preferred embodiments, it will be understood by those skilled in the art that variations and modifications of the preferred embodiments described above may be made without departing from the scope of the invention. Other embodiments will be apparent to those skilled in the art from a consideration of the specification or from a practice of the invention disclosed herein. It is intended that the specification and the described examples are considered exemplary only, with the true scope of the invention indicated by the following claims.

1. A method for controlling parameters of an operating stall controlled wind turbine, the method comprising:
measuring power output and revolutions per minute (RPM) of an operating stall controlled wind turbine at a specific TSR;
determining wind speed of the operating turbine using a model mapping a tip to wind speed ratio (TSR) for a model stall controlled wind turbine; and
upon reaching a determined or selected wind speed, controlling one selected from a group consisting of the power output of the operating turbine and the RPM of the operating turbine, such that a load on the operating turbine is reduced.

2. The method of claim 1, wherein determining wind speed of the operating turbine further comprises:
upon reaching peak power, varying the RPM required to maintain the peak power.

3. The method of claim 1, further comprising:
correcting the determined wind speed based on additional inputs.

4. The method of claim 3, wherein the additional inputs are selected from a group consisting of air temperature, altitude and blade inertia.

5. The method of claim 1, wherein, in a high wind speed, the operating turbine continues to operate at reduced load.

6. The method of claim 1, wherein, in a high wind speed condition, the operating turbine stops operation.

7. A method for controlling parameters of an operating stall controlled wind turbine, the method comprising:
measuring power output and revolutions per minute (RPM) of an operating stall controlled wind turbine at a specific TSR;
determining wind speed of the operating turbine, wherein upon reaching peak power, the RPM required to maintain the peak power is monitored; and
upon reaching a determined or selected wind speed, controlling one selected from a group consisting of the power output of the operating turbine and the RPM of the operating turbine, such that a load on the operating turbine is reduced.

8. The method of claim 7, wherein determining wind speed of the operating turbine further includes:
mapping a Ramp Start (RS) control for a desired wind speed range.

9. A system for controlling parameters of an operating stall controlled wind turbine, the system comprising:
means for measuring power output and revolutions per minute (RPM) of an operating stall controlled wind turbine at a specific TSR;
means for determining wind speed of the operating turbine using a model mapping a tip to wind speed ratio (TSR) for a model stall controlled wind turbine; and
means for controlling, upon reaching a determined or selected wind speed, one selected from a group consisting of the power output of the operating turbine and the RPM of the operating turbine, such that a load on the operating turbine is reduced.

10. The system of claim 9, wherein the means for determining wind speed of the operating turbine further comprises:
means for, upon reaching peak power, varying the RPM required to maintain the peak power.

11. The system of claim 9, further comprising:
means for correcting the determined wind speed based on additional inputs.

12. The system of claim 11, wherein the additional inputs are selected from a group consisting of air temperature, altitude and blade inertia.

13. The system of claim 9, wherein, in a high wind speed, the operating turbine continues to operate at reduced load.

14. The system of claim 9, wherein, in a high wind speed condition, the operating turbine stops operation.

15. A system for controlling parameters of an operating stall controlled wind turbine, the system comprising:
means for measuring power output and revolutions per minute (RPM) of an operating stall controlled wind turbine at a specific TSR;
means for determining wind speed of the operating turbine, wherein upon reaching peak power, the RPM required to maintain the peak power is monitored; and
means for controlling, upon reaching a determined or selected wind speed, one selected from a group consisting of the power output of the operating turbine and the RPM of the operating turbine, such that a load on the operating turbine is reduced.

16. The system of claim 15, wherein the means for determining wind speed of the operating turbine further includes:
means for mapping a Ramp Start (RS) control for a desired wind speed range.

17. A computer program product comprising a computer usable medium having control logic stored thereon for causing a computer to control parameters of an operating stall controlled wind turbine, the control logic comprising:
first computer readable program code means for measuring power output and revolutions per minute (RPM) of an operating stall controlled wind turbine at a specific TSR;
second computer readable program code means for determining wind speed of the operating turbine using a model mapping a tip to wind speed ratio (TSR) for a model stall controlled wind turbine; and
third computer readable program code means for controlling, upon reaching a determined or selected wind speed, one selected from a group consisting of the power output of the operating turbine and the RPM of the operating turbine, such that a load on the operating turbine is reduced.

18. The computer program product of claim 17, wherein the second computer readable program code means for determining wind speed of the operating turbine further comprises:
fourth computer readable program code means for, upon reaching peak power, varying the RPM required to maintain the peak power.

19. The computer program product of claim 17, further comprising:
fourth computer readable program code means for correcting the determined wind speed based on additional inputs.

20. The computer program product of claim 19, wherein the additional inputs are selected from a group consisting of air temperature, altitude and blade inertia.

21. The computer program product of claim 17, wherein, in a high wind speed, the operating turbine continues to operate at reduced load.

22. The computer program product of claim 17, wherein, in a high wind speed condition, the operating turbine stops operation.

23. A computer program product comprising a computer usable medium having control logic stored thereon for causing a computer to control parameters of an operating stall controlled wind turbine, the control logic comprising:
first computer readable program code means for measuring power output and revolutions per minute (RPM) of an operating stall controlled wind turbine at a specific TSR;
first computer readable program code means for determining wind speed of the operating turbine, wherein upon reaching peak power, the RPM required to maintain the peak power is monitored; and
first computer readable program code means for controlling, upon reaching a determined or selected wind speed, one selected from a group consisting of the power output of the operating turbine and the RPM of the operating turbine, such that a load on the operating turbine is reduced.

24. The computer program product of claim 23, wherein the second computer readable program code means for determining wind speed of the operating turbine further includes:
fourth computer readable program code means for mapping a Ramp Start (RS) control for a desired wind speed range.
